(19) United States
(12) Patent Application Publication
(10) Pub. No.: US 2014/0131336 A1
(43) Pub. Date: May 15, 2014

(54) QUICK CHANGE CONNECTION FOR MIG TORCH

(71) Applicant: Guy P. Jacques, Windsor (CA)

(72) Inventor: Guy P. Jacques, Windsor (CA)

(73) Assignee: ILLINOIS TOOL WORKS INC., Glenview, IL (US)

(21) Appl. No.: 13/791,016

(22) Filed: Mar. 8, 2013

Related U.S. Application Data
(60) Provisional application No. 61/724,585, filed on Nov. 9, 2012.

(51) Int. Cl. B23K 9/32

(52) U.S. Cl. CPC B23K 9/32
USPC 219/137.63

(57) ABSTRACT

A quick change connection for a MIG welding torch having a torch body and a disconnectable gooseneck includes a ball locking mechanism disposed at a front end of the torch body. A connector disposed at a rear end of the gooseneck and cooperable with the ball locking mechanism. The ball locking mechanism mates with the connector to securely retain the gooseneck in the torch body, and release of the ball locking mechanism allows the gooseneck to be separated from the torch body.

### CROSS REFERENCE TO RELATED APPLICATION

This application claims the priority of U.S. Provisional Application No. 61/724,585 filed Nov. 9, 2012.

### TECHNICAL FIELD

This invention relates to welding torches, and more particularly to the connection of a welding torch neck to a welding torch body.

### BACKGROUND OF THE INVENTION

It is known in the art relating to welding torches that a neck of welding torch is removable from the torch body. The welding torch neck must be held by a fastening system that is designed to ensure that the neck is: (a) held firmly to the torch body; (b) electrically connected to the torch body; and (c) incapable of loosening or releasing from the torch body during use.

### SUMMARY OF THE INVENTION

Disclosed is a fastening system that allows a welding torch neck to be easily removed and replaced without the use of a tool. The fastening system also provides for repeat positioning of the neck at the tool center point of the welding torch. The fastening system further allows for simple and reliable changing of the welding torch neck by an automated neck changing station.

More particularly, a quick change connection for a MIG torch having a torch body and a disconnectable gooseneck includes a ball locking mechanism disposed at a front end of the torch body. A connector disposed at a rear end of the gooseneck and cooperable with the ball locking mechanism. The ball locking mechanism mates with the connector to securely retain the gooseneck in the torch body, and release of the ball locking mechanism allows the gooseneck to be separated from the torch body.

The ball locking mechanism includes a cage. The cage has a plurality of apertures therein. The ball locking mechanism also includes a tubular collar including a tapered inner surface facing the cage. The ball locking mechanism further includes a plurality of locking balls each resting in one of the apertures and held in the cage by the tapered inner surface of the collar. The collar is moveable about the front end of the torch body along a longitudinal axis of the torch body to lock and unlock the ball locking mechanism.

In one embodiment, the connector may include an annular surface having a wider diameter portion and an inwardly disposed smaller diameter portion. The annular surface also may include a sloped portion between the smaller diameter portion and the wider diameter portion. The locking balls contact the sloped portion to secure the gooseneck in the torch body. A tubular extension in communication with a through passage in the gooseneck may extend axially from a rear face of the connector adjacent the annular surface. The tubular extension is receivable in a through passage in the torch body. The collar may be slidable along the longitudinal axis of the torch body, and biased by a spring.

In a specific embodiment, a quick change connection for a MIG torch having a torch body and a disconnectable gooseneck includes a receiver formed in the torch body and having an opening at a front end of the torch body. A cage is disposed adjacent the receiver at the front end of the torch body. A tubular collar including a tapered inner surface at an end thereof is moveable about the front end of the torch body along a longitudinal axis of the torch body. A plurality of locking balls are held in the cage by the tapered inner surface of the collar. A plurality of apertures are formed in the cage, and each locking ball rests in a separate one of the apertures. A connector is disposed at a rear end of the gooseneck. The connector includes an annular surface having a wider diameter portion and an inwardly disposed smaller diameter portion. The connector is receivable in the receiver of the torch body. Outward movement of the collar along the longitudinal axis causes the tapered inner surface to force the locking balls radially inward into the apertures and adjacent the smaller diameter portion of the connector, thereby retaining the gooseneck in the torch body. Inward movement of the collar along the longitudinal axis moves the tapered inner surface relative to the locking balls, allowing the locking balls to move radially outward to allow for release of the gooseneck from the torch body.

The annular surface includes a sloped portion between the smaller diameter portion and the wider diameter portion. The locking balls contact the sloped portion to secure the gooseneck in the torch body. A locating pin extends axially from a rear face of the connector adjacent the annular surface. The locating pin is receivable in a corresponding receiver in the torch body for alignment of the gooseneck relative to the torch body. A tubular extension in communication with a through passage in the gooseneck extends axially from the rear face of the connector. The tubular extension is receivable in a through passage in the torch body.

Optionally, the collar may include grooves on an outer surface thereof for facilitating gripping of the collar. The collar may be slidable along the longitudinal axis of the torch body and may be biased by a spring. Alternatively, the collar may be threaded onto the torch body such that rotation of the collar moves the collar along the longitudinal axis of the torch body.

These and other features and advantages of the assembly will be more fully understood from the following detailed description of the invention taken together with the accompanying drawings.

### BRIEF DESCRIPTION OF THE DRAWINGS

In the drawings:

FIG. 1 is a perspective view of an assembled MIG welding torch mounted on a robotic arm;

FIG. 2 is a side view of the MIG welding torch including a torch body and a gooseneck attached to the torch body by a quick change connection;

FIG. 3 is a side view of the MIG welding torch illustrating the gooseneck disconnected from the torch body;

FIG. 4 is a cross-sectional view of the MIG welding torch;

FIG. 5 is a perspective view of the gooseneck separated from the torch body; and

FIG. 6 is a cross-sectional view of an alternative embodiment of the MIG welding torch.

### DETAILED DESCRIPTION OF THE INVENTION

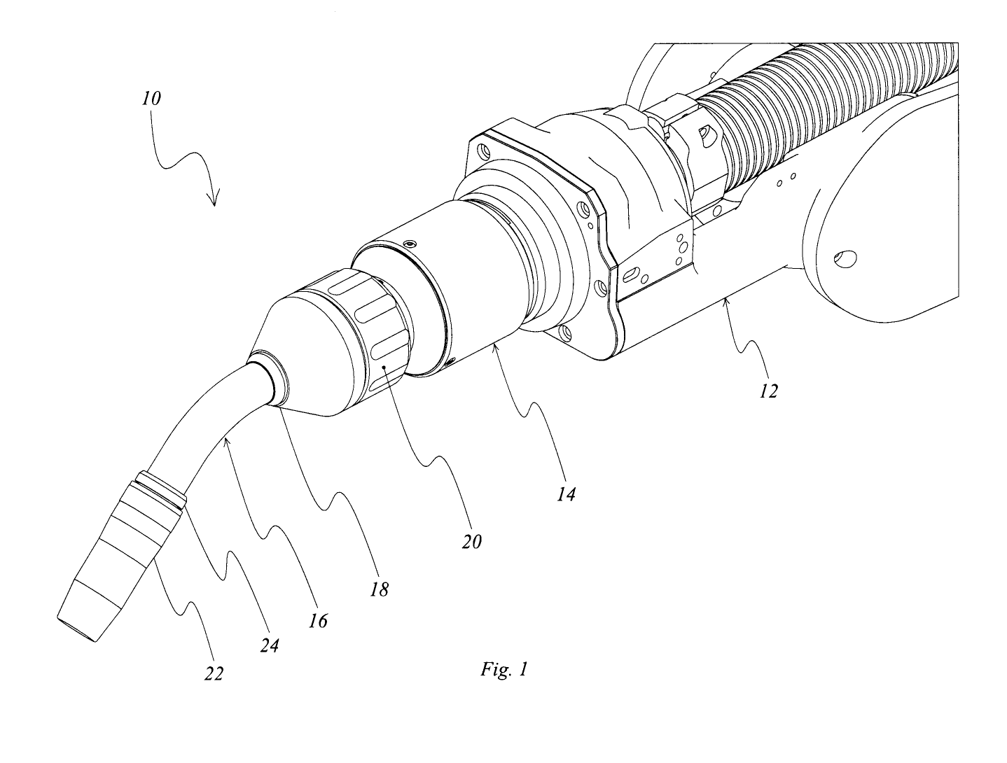

Referring to FIG. 1 of the drawings in detail, numeral 10 generally indicates a MIG welding torch mounted on a robotic arm 12. The MIG welding torch 10 includes a torch body 14 and a disconnectable gooseneck 16 having a rear end 18 attached to a front end 20 of the torch body 14. A contact tip assembly 22 is connected to a front end 24 of the gooseneck 16 opposite the torch body 14.

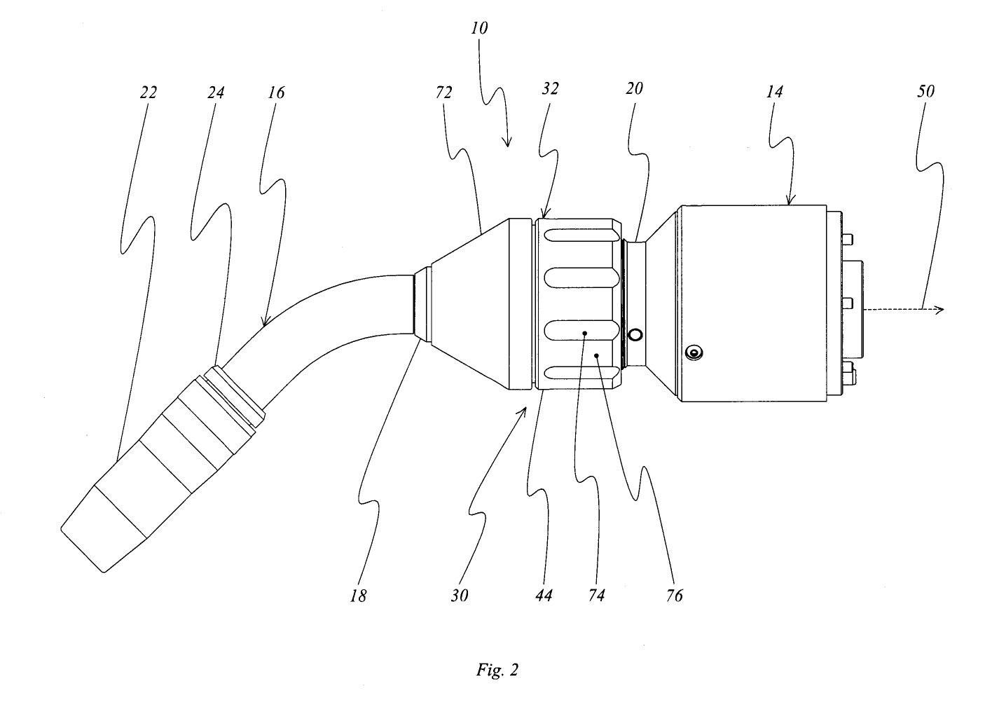

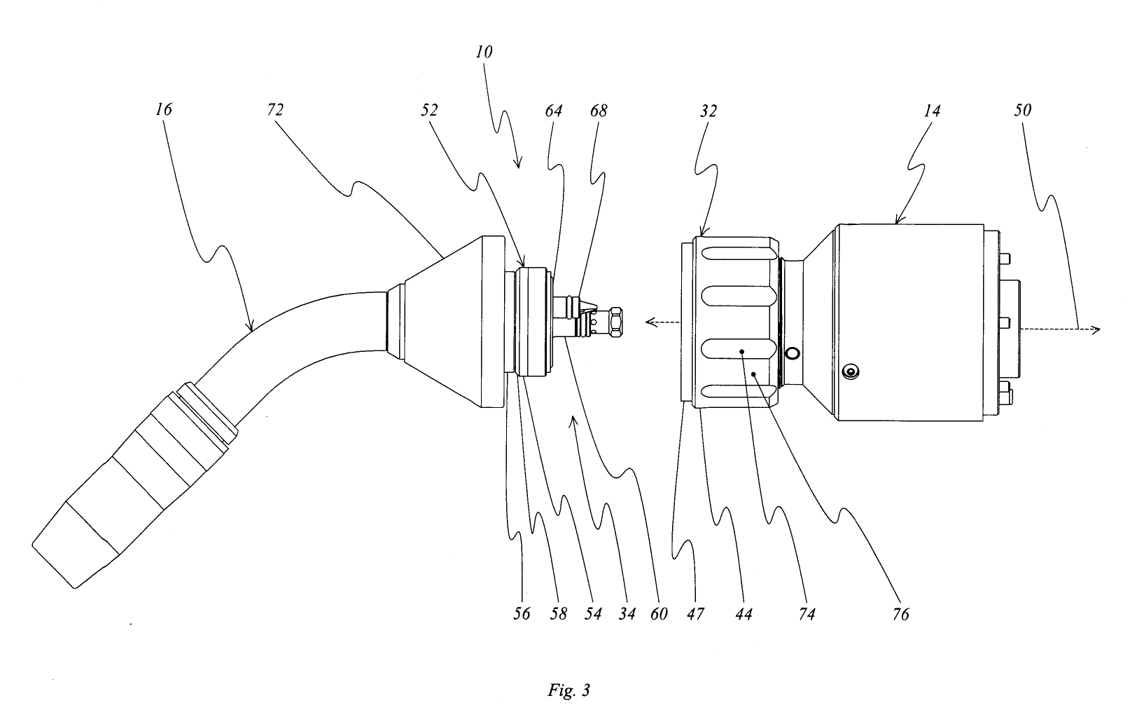

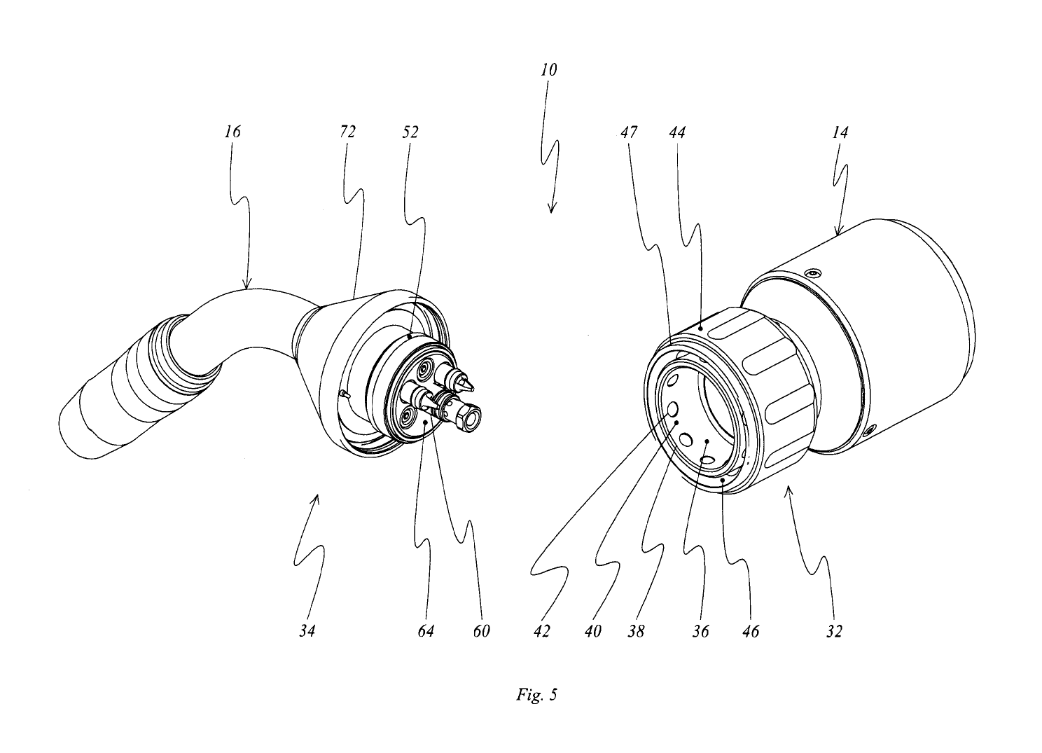

Turning to FIGS. 2-5, the MIG welding torch 10 includes a quick change connection 30 for releasably fastening the gooseneck 16 to the torch body 14. The quick change connection 30 generally includes a ball locking mechanism 32 and a connector 34. The ball locking mechanism 32 is disposed at the front end 20 of the torch body 14. The connector 34 is disposed at the rear end 18 of the gooseneck 16 and is cooperable with the ball locking mechanism 32. The ball locking mechanism 32 mates with the connector 34 to securely retain the gooseneck 16 in the torch body 14, and release of the ball locking mechanism 32 allows the gooseneck 16 to be easily separated from the torch body 14 so that the gooseneck may be replaced with a new gooseneck or exchanged for a different gooseneck, such as one having a different shape or size.

A receiver 36 is formed in the torch body 14 and has an opening 38 at the front end 20 of the torch body. The ball locking mechanism 32 includes a cage 40 disposed adjacent the receiver 36 at the torch body front end 20. The cage 40 has a plurality of apertures 42 formed therein. A tubular collar 44 is mounted on the torch body 14 and includes a tapered inner surface 46 at one end. The tapered inner surface 46 faces the cage 40. The tapered inner surface 46 may be integral with the collar 44 or may be formed by a ring 47 that is connected to and extends from the end of the collar. A plurality of locking balls 48 each rest in one of the apertures 42 and are held in the cage 40 by the tapered inner surface 46 of the collar 44. The collar 44 is moveable about the front end 20 of the torch body 14 along a longitudinal axis 50 of the torch body to lock and unlock the ball locking mechanism 32 as described in more detail below.

The connector 34 includes an annular surface 52 having a wider diameter portion 54, an inwardly disposed smaller diameter portion 56, and a sloped portion 58 interposed between the smaller diameter portion and the wider diameter portion. The connector 34 is receivable in the receiver 36 of the torch body 14 such that the connector is disposed in the ball locking mechanism 32. In a locked disposition, the locking balls 48 contact the sloped portion 58 of the annular surface 52 to secure the gooseneck 16 in the torch body 14.

A tubular extension 60 in communication and colinear with a through passage 62 in the gooseneck 16 extends axially from a rear face 64 of the connector 34 adjacent the annular surface 52. The tubular extension 60 is receivable in a through passage 66 in the torch body 14 at an end of the through passage that is adjacent the receiver 36. When the gooseneck 16 is connected to the torch body 14, consumable welding wire and shielding gas travel along the through passage 66 of the torch body and into the through passage 62 of the gooseneck via the tubular extension 60. The tubular extension 60 centers the gooseneck 16 relative to the torch body 14, thereby axially positioning the gooseneck. One or more locating pins 68 also extend axially from the rear face 64 of the connector 34. The locating pin 68 is receivable in a corresponding receiver in the torch body 14 for radial alignment of the gooseneck 16 relative to the torch body. The tubular extension 60 and locating pin 68 together properly align the gooseneck 16 in the torch body 14 to assure repeatable tool center point positioning of the contact tip assembly 22 at the front end 24 of the gooseneck when a gooseneck is mounted on the torch body.

The gooseneck 16 may include a cap 72 proximate the connector 34 and the gooseneck rear end 18. The cap 72 may have a generally truncated conical shape that increases in diameter from the tubular body of the gooseneck to a diameter that is generally equal to the outer diameter of the collar 44 on the torch body 14. The outer edge of the cap 72 may just fit over and around the an outer edge of the ring 47 that forms the tapered inner surface 46 of the collar 44 to seal the connection between the gooseneck 16 and the torch body 14.

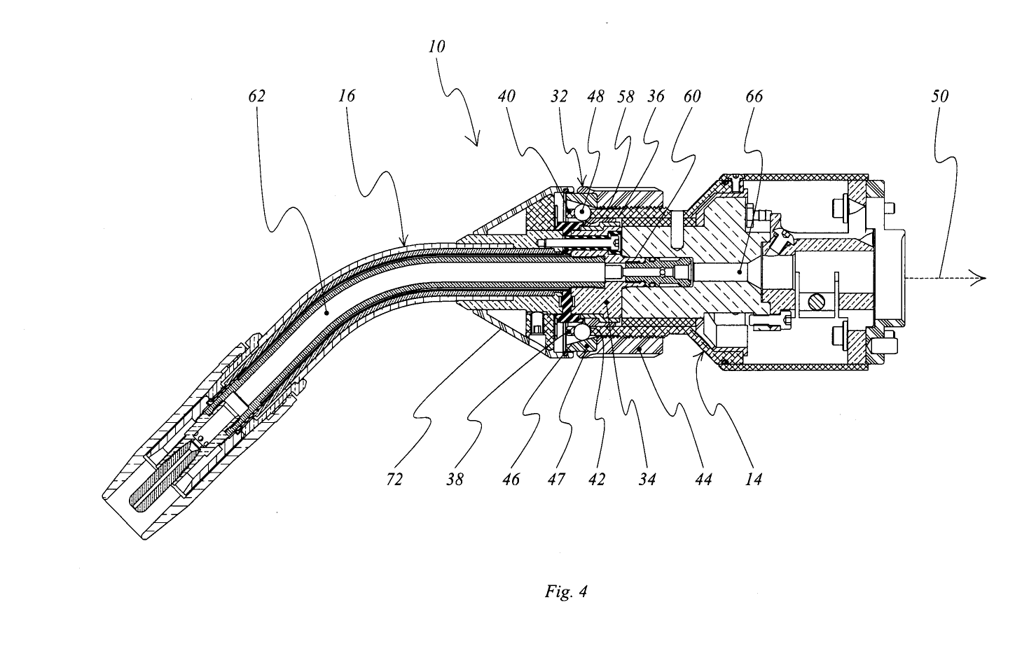

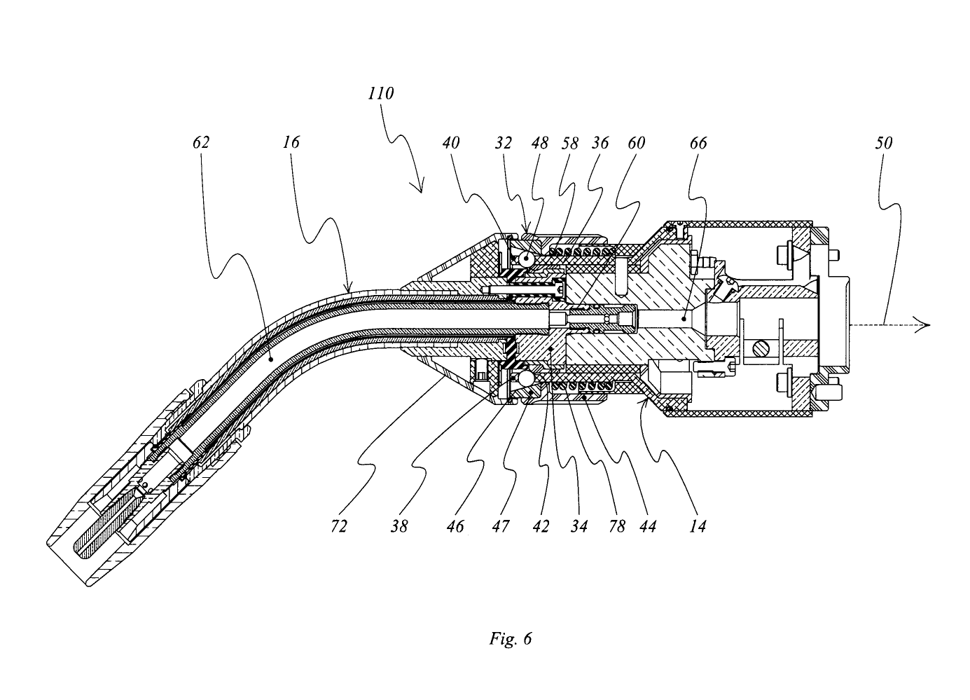

To secure the gooseneck 16 in the torch body 14, the collar 44 is moved inwardly (away from the front end 20 of the torch body 14) along the longitudinal axis 50 of the torch body. In one embodiment shown in FIG. 4, the collar 44 is threaded onto the torch body 14 such that rotation of the collar moves the collar along the longitudinal axis 50 of the torch body. Alternatively, in another embodiment 110 shown in FIG. 6 the collar 44 is slidable along the longitudinal axis 50 of the torch body 14 and is biased in an outward direction (towards the torch body front end 20) by a spring 78. The collar 44 also includes grooves 74 or other similar surface pattern on an outer surface 76 for facilitating gripping of the collar by a hand of a human operator (in the case of manual installation or change of a gooseneck). Alternatively, the gooseneck 16 may be installed and/or substituted for another gooseneck in an automated neck changing station which, for example, uses air pressure to move the collar.

As the collar 44 is moved inwardly, the tapered inner surface 46 moves relative to the locking balls 48, allowing the locking balls freedom to move radially outward. The connector 34 of the gooseneck 16 is inserted into the receiver 36. The collar 44 is then moved outwardly along the longitudinal axis 50 of the torch body 14. For example, in the case that the collar 44 is spring-loaded and slidable along the torch body 14, the human operator may release his grip on the collar, allowing the spring to return the collar to its outward (forward) resting position. Alternatively, if the collar is threaded on the torch body, the operator would rotate the collar in a direction that causes the collar to move outwardly along the longitudinal axis. Outward movement of the collar 44 causes the tapered inner surface 46 to force the locking balls 48 radially inward into the apertures adjacent the smaller diameter portion 56 of the connector 34 and up against the sloped portion 58 of the connector. The gooseneck 16 is thereby forced towards the torch body 14, thereby clamping and retaining the gooseneck in the torch body.

Subsequently, to replace the gooseneck 16, the collar 44 is moved inwardly along the longitudinal axis 50 of the torch body 14. The inward movement of the collar 44 moves the tapered inner surface 46 relative to the locking balls 48, allowing the locking balls to freely move radially outward. The gooseneck 16 is pulled outwardly away from the torch body 14, and the locking balls 48 are forced outward by the wider diameter portion 54 of the connector 34 to allow for release of the gooseneck from the torch body.

The quick change connection thereby securely fastens the gooseneck to the torch body with or without the use of tools, and provides for simple changing of goosenecks by a human operator or an automated neck changing station.

Although the assembly has been described by reference to a specific embodiment, it should be understood that numerous changes may be made within the spirit and scope of the inventive concepts described. Accordingly, it is intended that the assembly not be limited to the described embodiment, but that it have the full scope defined by the language of the following claims.

what is claimed is:

1. A quick change connection for a MIG welding torch having a torch body and a disconnectable gooseneck, said quick change connection comprising:
a ball locking mechanism disposed at a front end of said torch body;
a connector disposed at a rear end of said gooseneck and cooperable with said ball locking mechanism;
wherein said ball locking mechanism mates with said connector to securely retain said gooseneck in said torch body, and release of said ball locking mechanism allows said gooseneck to be separated from said torch body.

2. The quick change connection of claim 1, wherein said ball locking mechanism includes a cage, said cage having a plurality of apertures therein, a tubular collar including a tapered inner surface facing said cage, and a plurality of locking balls each resting in one of said apertures and held in said cage by said tapered inner surface of said collar, said collar being moveable about said front end of said torch body along a longitudinal axis of said torch body to lock and unlock said ball locking mechanism.

3. The quick change connection of claim 1, wherein said connector includes an annular surface having a wider diameter portion and an inwardly disposed smaller diameter portion.

4. The quick change connection of claim 1, wherein said annular surface includes a sloped portion between said smaller diameter portion and said wider diameter portion, and said locking balls contact said sloped portion to secure said gooseneck in said torch body.

5. The quick change connection of claim 1, including a tubular extension in communication with a through passage in said gooseneck, said tubular extension extending axially from a rear face of said connector adjacent said annular surface, and said tubular extension being receivable in a through passage in said torch body.

6. The quick change connection of claim 1, wherein said collar is slidable along said longitudinal axis of said torch body and is biased by a spring.

7. A quick change connection for a MIG welding torch having a torch body and a disconnectable gooseneck, said quick change connection comprising:
a receiver formed in said torch body and having an opening at a front end of said torch body;
a cage disposed adjacent said receiver at said front end of said torch body;
a tubular collar including a tapered inner surface at an end thereof, said collar being moveable about said front end of said torch body along a longitudinal axis of said torch body;
a plurality of locking balls held in said cage by said tapered inner surface of said collar;
a plurality of apertures in said cage, each said locking ball resting in one of said apertures;
a connector disposed at a rear end of said gooseneck, said connector including an annular surface having a wider diameter portion and an inwardly disposed smaller diameter portion;
said connector being receivable in said receiver of said torch body;
wherein outward movement of said collar along said longitudinal axis causes said tapered inner surface to force said locking balls radially inward into said apertures and adjacent said smaller diameter portion of said connector, thereby retaining said gooseneck in said torch body; and
inward movement of said collar along said longitudinal axis moves said tapered inner surface relative to said locking balls, allowing said locking balls to move radially outward to allow for release of said gooseneck from said torch body.

8. The quick change connection of claim 7, wherein said annular surface includes a sloped portion between said smaller diameter portion and said wider diameter portion, and said locking balls contact said sloped portion to secure said gooseneck in said torch body.

9. The quick change connection of claim 7, including a locating pin extending axially from a rear face of said connector adjacent said annular surface, said locating pin being receivable in a corresponding receiver in said torch body for alignment of said gooseneck relative to said torch body.

10. The quick change connection of claim 7, including a tubular extension in communication with a through passage in said gooseneck, said tubular extension extending axially from a rear face of said connector adjacent said annular surface, and said tubular extension being receivable in a through passage in said torch body.

11. The quick change connection of claim 7, wherein said collar includes grooves on an outer surface for facilitating gripping of said collar.

12. The quick change connection of claim 7, wherein said collar is slidable along said longitudinal axis of said torch body and is biased by a spring.

13. The quick change connection of claim 7, wherein said collar is threaded onto said torch body such that rotation of said collar moves said collar along said longitudinal axis of said torch body.

14. A MIG welding torch including the quick change connection of claim 1.

15. A MIG welding torch including the quick change connection of claim 7.
